(19) United States
(12) Patent Application Publication
(10) Pub. No.: US 2023/0295380 A1
(43) Pub. Date: Sep. 21, 2023

(54) SILICONE COPOLYMERS, THEIR PREPARATION AND THEIR USE FOR THE TREATMENT OF FIBROUS SUBSTRATES

(71) Applicant: WACKER CHEMIE AG, Munich (DE)

(72) Inventors: Heng YANG, Shanghai (CN); Shuai TIAN, Shanghai (CN)

(73) Assignee: Wacker Chemie AG, Munich (DE)

(21) Appl. No.: 18/020,975

(22) PCT Filed: Sep. 8, 2020
(86) PCT No.: PCT/CN2020/113956

§ 371 Date: Mar. 17, 2023

(51) Int. Cl. C08G 77/388; C08G 77/455; D06M 15/643

(52) U.S. Cl. CPC C08G 77/388; C08G 77/455; D06M 15/643; D06M 2200/50; D06M 2200/10

(57) ABSTRACT

The method relates to the technical field of organic silicone copolymers, it is suitable for the field of fiber substrate treatment and is more suitable for the field of textile treatment.

### TECHNICAL FIELD

The invention relates to the technical field of organic silicone copolymers; which is suitable for the field of fiber substrate treatment; and more preferable for the field of textile treatment.

### BACKGROUND ART

U.S. Pat. No. 7,501,184B2 or CN101346414B describes copolymers which are obtained by reaction of linear organopolysiloxanes, terminated with oxamidoester groups, with organic diamines. The copolymers obtained, which have a high viscosity or are solid, are used in adhesives, especially as hotmelt adhesives. These high-viscosity products are not stably emulsifiable and therefore cannot be integrated into the textile application chain.

WO2019114953A1 discloses a silicone copolymer containing oxamide, which is obtained by an organopolysiloxane terminated by oxamidoester groups, a polyetheramine and a monofunctional primary or secondary amine under mixing and stirring conditions.

### SUMMARY OF THE INVENTION

The invention discloses a new type of organosilicon copolymer, which is used to treat a fiber substrate, so that the treated fiber substrate has better hydrophilicity and hand feeling and can also possess additional antibacterial effects at the same time.

The inventive silicone copolymer contains a structural unit represented by the general formula (I-a),

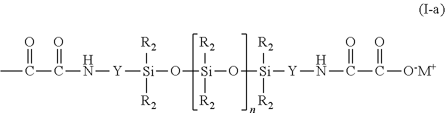

M is N(R¹)₄, R¹ is the same or different, and represents a monovalent hydrocarbon group having 1 to 18 carbon atoms, benzyl or adamantyl, preferably R¹ is methyl, ethyl, propyl, butyl, benzyl, dodecyl, octadecyl, more preferably R¹ is methyl,
Y is a divalent hydrocarbon group, optionally substituted by one or more heteroatoms, preferably methylene, 1,2-ethylene, 1,3-propylene, 1,3-butylene, 1,4-butylene, 1,5-pentylene, 1,6-hexylene, —C₂H₄—NH—C₃H₆—; more preferably 1,3-propylene;
R² is identical or different and denotes a monovalent hydrocarbon radical which has 1 to 18 carbon atoms and may comprise halogen or oxygen atoms,
n is an integer from 10 to 2000, preferably an integer from 10 to 300.

Preferably, R² is alkyl, cycloalkyl, alkenyl, alkynyl, aryl, alkaryl, aralkyl. R² is selected from methyl, ethyl, n-propyl, isopropyl, n-butyl, isobutyl, tert-butyl, n-pentyl, isopentyl, neopentyl, tert-pentyl, hexyl such as n-hexyl, Heptyl such as n-heptyl, octyl such as n-octyl and isooctyl, such as 2,2,4-trimethylpentyl, nonyl such as n-nonyl, decyl such as n-decyl, dodecyl Examples include n-dodecyl, and octadecyl, such as n-octadecyl; cyclopentyl, cyclohexyl, cycloheptyl, and methylcyclohexyl; vinyl, 5-hexenyl, cyclohexene Phenyl, 1-propenyl, allyl, 3-butenyl and 4-pentenyl; ethynyl, propargyl and 1-propynyl; phenyl, naphthyl, anthryl and phenanthryl; O-tolyl, m-tolyl and p-tolyl, xylyl and ethylphenyl; benzyl, α- and β-phenethyl.

More preferably, R² is methyl.

The silicone copolymers of the invention differ from the high molecular weight copolymers described in U.S. Pat. No. 7,501,184 in having a much lower molecular weight and containing different types of hydrophilic groups. The difference from the copolymer described in WO2019114953A1 is that: the terminal group of the present invention is more hydrophilic and can provide antibacterial function at the same time.

The silicone copolymers preferably have a molecular weight Mn (number average) of 4000-30000 g/mol, preferably 4000-20000 g/mol, more preferably 4000-15000 g/mol. This number-average molecular weight Mn is determined for the purposes of the present invention preferably by size exclusion chromatography (SEC).

The number-average molecular weight Mn is more preferably measured by size exclusion chromatography (SEC) against polystyrene standards, in toluene, at 45° C., a flow rate of 0.3 ml/min, and detection by RI (refractive index detector) on a PLgel MiniMIX-C column set from Agilent, with the injection volume of 20 μl.

The copolymer as described above contains the structural unit represented by the general formula (I-b)

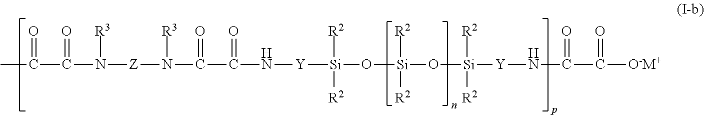

the group M is as defined above,
the group Z is a divalent hydrocarbyloxy group, preferably a polyethylene glycol group or a polypropylene glycol group or a mixture of a polyethylene glycol group and a polypropylene glycol group; the preferred molecular weight of the group Z is 120-4500 g/mol, more preferably 500-1800 g/mol,
wherein R³ are the same or different, and are selected from hydrogen atoms or monovalent hydrocarbon groups with 1 to 20 carbon atoms,
p is an integer of 1 to 5, preferably an integer of 1 to 2, and more preferably 1.

The copolymer as described above contains the structural unit represented by the general formula (I-c):

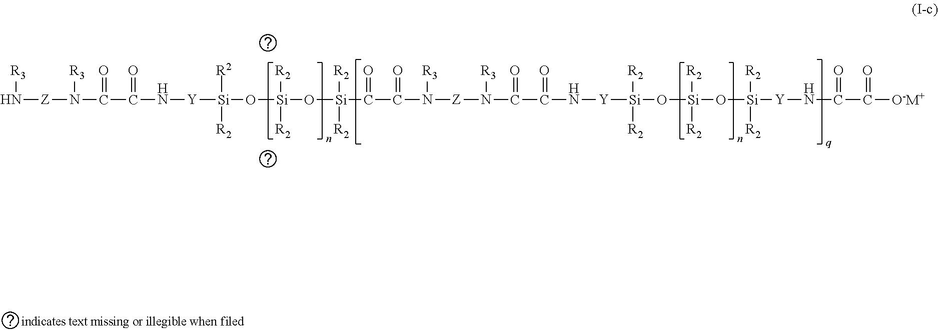

the groups M, R², and R³ are as defined above,
q is 0 or an integer of 1 to 5, preferably 0 or an integer of 1 to 2, more preferably 0 or 1.

The copolymer as described above contains the structural unit represented by the general formula (I-d) and/or (I-d′):

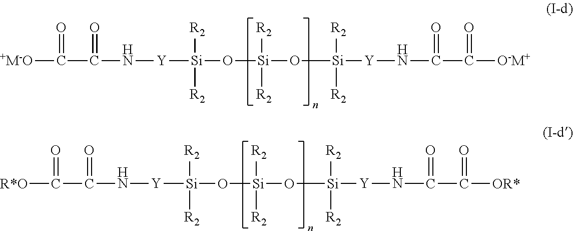

the groups M and R² are as defined above,
R* is a monovalent hydrocarbon group having 1 to 18 carbon atoms, preferably methyl or ethyl, more preferably ethyl.

A method for preparing the copolymer as described above is obtained by
(1) An organopolysiloxane containing a structural unit represented by general formula (II)

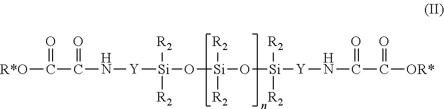

where R², Y, and n have the above-mentioned definitions for their indications, and
R* is a monovalent hydrocarbon group having 1 to 18 carbon atoms, preferably methyl or ethyl, more preferably ethyl,
react with the following Component (3), and optional Component (2):
Quaternary amine base Component (3) represented by general formula (III-3) compound

N(R¹)₄⁺X⁻ (III-3)
where R¹ has the same definition as above, X is OH,
wherein (2) is the polyetheramine of R³HN—Z—NHR³ (III-2), R³ and Z have the definitions indicated above.

In the present invention, it may also contain a small amount of (33) primary or secondary amines of formula H—N(R⁴)—R⁵ (IV), wherein R⁴ represents a hydrogen atom or a C1-18 alkyl group or a hydrocarbon group having 4 to 18 carbon atoms with one or more oxygen atoms or nitrogen atoms, and R⁵ represents a C1-18 alkyl group or a hydrocarbon group having 4 to 18 carbon atoms with one or more oxygen atoms or nitrogen atoms. However, the amount of (33) should be less than or equal to 200 mol %, preferably less than or equal to 120 mol %, and component (1) is calculated as 100 mol %.

Preferred examples of amines of the formula H—N(R⁴)—R⁵ (IV) are
primary amines, such as
H—NH—(CH₂)₃—N(CH₃)₂ (N¹,N¹-dimethylpropane-1,3-diamine)
secondary amines, such as
H—N—[(CH₂)₃—N(CH₃)₂]₂ (N¹-(3-(dimethylamino)propyl)-N³,N³-dimethylpropane-1,3-diamine)
primary polyetheramines such as
HNH—(CH₂)₃—OCH₂CH₃, HNH—(CH₂)₂—OCH₂CH₃,
secondary polyetheramines such as
NH—[(CH₂)₃—OCH₂CH₃]₂, NH—[(CH₂)₂—OCH₂CH₃]₂.

In the method described above, the quaternary amine base Component (3) is used in the following amount: relative to every 100 moles of polymer in the organopolysiloxane (1), the amount of component (3) is greater than or equal to 10 mol, preferably greater than or equal to 20 mol, It is preferably 30 mol or more, for example 35, 45, 55, 65, 70, 100, 150 mmol, and more preferably between 40-400 mol, more preferably between 50-300 mol, more preferably between 60-200 mol.

The method described above, wherein the reaction is performed at 70-120° C. and a vacuum of 30-70 mbar, preferably 40-60 mbar.

The method as described above, wherein the reaction time is between 0.5-5 h, preferably between 1-3 h.

In the method as described above, the water content of the reactant is less than 1 wt %, preferably less than 0.1 wt %, and the component (1) is calculated as 100 wt %.

As the method described above, wherein the reaction is carried out in the presence of alcohol R¹OH, wherein the definition of R¹ is the same as above, preferably methanol or ethanol.

As the method described above, wherein the quaternary amine base component (3) is mixed with the solvent in advance to obtain a quaternary amine base component (3) solution or a quaternary amine base component (3) dispersion.

As the above method, the preferred solvent meets the following conditions. Under the condition of 20° C. and 1 atm, 100 g solvent can dissolve 1 g or more of the quaternary amine base component (3).

In the method described above, the water content of the quaternary amine base component (3) solution or the quaternary amine base component (3) dispersion is less than or equal to 10 wt %, preferably less than or equal to 8 wt %.

In the above method, the quaternary amine base component (3) is not pre-mixed with the solvent, that is, it is mixed with the component (1) the organopolysiloxane.

In the above method, the quaternary amine base component (3) may coexist with part of the water of crystallization, preferably the content of the water of crystallization is less than or equal to 100 wt %, preferably less than or equal to 80 wt %, more preferably less than or equal to 60 wt %, based on 100 wt % the quaternary amine base component (3).

In the method described above, the polyetheramine (2) can optionally be used in amount of 0.3 to 2 mol, or 0.5, 0.8, 1, 1.2, 1.4, 1.6, 1.8 mol, preferably 0.4 to 0.6 mol, more preferably 0.5 mol of amino group in (2) per mole of polymer in organopolysiloxane (1).

A composition obtained by the above method.

A composition containing the copolymer as described above, the copolymer containing a structural unit represented by the general formula (I-a).

A composition containing the copolymer as described above, the copolymer containing a structural unit represented by the general formula (I-b).

A composition containing the copolymer as described above, the copolymer containing a structural unit represented by the general formula (I-c).

A composition containing the copolymer as described above, the copolymer containing a structural unit represented by the general formula (I-d) and/or (I-d′).

An Aqueous Emulsion Includes:
Composition (A) contains the silicone copolymer as described above,
Emulsifier (B) and/or co-emulsifier (B′), and
Water (C).

In the above-mentioned aqueous emulsion, where is the amount of component (A) used between 10-50 wt %, preferably between 15-40 wt % based on the total amount of aqueous emulsion is calculated as 100 wt %.

The use of the copolymer or composition or emulsion as described above in the textile field; preferably the use of improving the hydrophilicity and/or hand feel of textiles.

The use as described above; preferably the use of simultaneously improving the hydrophilicity and antibacterial properties of textiles.

In a method, said composition is applied to the fibrous substrate, and the fibrous substrate thus treated is dried at a temperature of preferably 20 to 200° C.

In the method as described above, the fiber substrate is a textile.

Emulsifiers (B) used may be nonionic, anionic or cationic emulsifiers or else mixtures thereof.

The aqueous emulsions of the invention comprise emulsifiers that are known per se, and mixtures thereof.

Particularly Suitable Anionic Emulsifiers Include:

1. Alkyl sulfates, particularly those having a chain length of 8 to 18 carbon atoms, alkyl and alkaryl ether sulfates having 8 to 18 carbon atoms in the hydrophobic radical and 1 to 40 ethylene oxide (EO) and/or propylene oxide (PO) units.

2. Sulfonates, particularly alkylsulfonates having 8 to 18 carbon atoms, alkylarylsulfonates having 8 to 18 carbon atoms, taurides, esters and monoesters of sulfosuccinic acid with monohydric alcohols or alkylphenols having 4 to 15 carbon atoms; these alcohols or alkylphenols may optionally also be ethoxylated with 1 to 40 EO units.

3. Alkali metal salts and ammonium salts of carboxylic acids having 8 to 20 carbon atoms in the alkyl, aryl, alkaryl or aralkyl radical.

4. Phosphoric acid partial esters and their alkali metal and ammonium salts, particularly alkyl and alkaryl phosphates having 8 to 20 carbon atoms in the organic radical, alkyl ether and alkaryl ether phosphates having 8 to 20 carbon atoms in the alkyl or alkaryl radical, respectively, and 1 to 40 EO units.

Particularly Suitable Nonionic Monomers Include:

5. Polyvinyl alcohol additionally having 5 to 50%, preferably 8 to 20%, of vinyl acetate units, with a degree of polymerization of 500 to 3000.

6. Alkyl polyglycol ethers, preferably those having 8 to 40 EO units and alkyl radicals of 8 to 20 carbon atoms.

7. Alkyl aryl polyglycol ethers, preferably those having 8 to 40 EO units and 8 to 20 carbon atoms in the alkyl and aryl radicals.

8. Ethylene oxide/propylene oxide (EO/PO) block copolymers, preferably those having 8 to 40 EO and PO units.

9. Adducts of alkylamines having alkyl radicals of 8 to 22 carbon atoms with ethylene oxide or propylene oxide.

10. Fatty acids having 6 to 24 carbon atoms.

11. Alkyl polyglycosides of the general formula R**—O-Zo, in which R** denotes a linear or branched, saturated or unsaturated alkyl radical having on average 8-24 carbon atoms and Zo denotes an oligoglycosides radical having on average o=1-10 hexose or pentose units or mixtures thereof.

12. Natural substances and their derivatives, such as lecithin, lanolin, saponins, cellulose; cellulose alkyl ethers and carboxyalkyl celluloses in which the alkyl groups each possess up to 4 carbon atoms.

13. Linear organo(poly)siloxanes containing polar groups, especially those with alkoxy groups having up to 24 carbon atoms and/or up to 40 EO and/or PO groups.

Particularly Suitable Cationic Emulsifiers Include:

14. Salts of primary, secondary, and tertiary fatty amines having 8 to 24 carbon atoms with acetic acid, sulfuric acid, hydrochloric acid, and phosphoric acids.

15. Quaternary alkylammonium and alkylbenzeneammonium salts, more particularly those whose alkyl groups possess 6 to 24 carbon atoms, especially the halides, sulfates, phosphates, and acetates.

16. Alkylpyridinium, alkylimidazolium and alkyloxazolinium salts, more particularly those whose alkyl chain possesses up to 18 carbon atoms, especially the halides, sulfates, phosphates, and acetates.

Particularly Suitable Ampholytic Emulsifiers Include:

17. Amino acids with long-chain substitution, such as N-alkyl-di(aminoethyl)glycine or salts of N-alkyl-2-aminopropionic acid.

18. Betaines, such as N-(3-acylamidopropyl)-N,N-dimethylammonium salts having a C8-C18 acyl radical, and alkylimidazolium betaines.

Preferred emulsifiers are nonionic emulsifiers, especially the alkyl polyglycol ethers listed above under 6., the adducts of alkylamines with ethylene oxide or propylene oxide, listed under 9., the alkyl polyglycosides listed under 11., and the polyvinyl alcohols listed under 5.

Emulsifiers are used here in amounts of 1 wt % to 70 wt %, based on the total weight of the aqueous emulsions.

The aqueous emulsions comprise copolymers of the invention preferably in amounts of 0.5 wt % to 80 wt %, based on the total weight of the aqueous emulsions.

The aqueous emulsions of the invention may also comprise further substances, such as polyethylene glycols, polypropylene glycols and polyethylene-polypropylene glycols and mixtures thereof, and also acids. Examples of acids are carboxylic acids, such as acetic acid, formic acid, citric acid, malic acid and lactic acid.

Further substances that may be present in the aqueous emulsions of the invention include solvents or coemulsifiers (B′).

Examples of nonaqueous solvents or coemulsifiers are 1-pentanol, 1-hexanol, 1-octanol, propanediol, 1,3-butanediol, 1,2-hexanediol, 2-ethylhexane-1,3-diol, 1,2-octanediol, glycerol, diethylene glycol methyl ether, diethylene glycol ethyl ether, diethylene glycol mono-n-butyl ether, propylene glycol methyl ether.

The organopolysiloxanes (1) of the formula (II) that are used in the process of the invention may be prepared by the processes described in U.S. Pat. No. 7,501,184 B2 (incorporated by reference), especially column 13, lines 14 to 48. The skilled person is also aware of other processes.

Examples of the polyetheramines (2) used in the process of the invention are Jeffamine® diamines of series D and ED, available commercially from Huntsman, such as Jeffamine® D-230, Jeffamine® D-400, Jeffamine® D-2000, Jeffamine® HK 511, Jeffamine® ED-600, Jeffamine® ED-900 and Jeffamine® ED-2003.

In the method of the present invention, it is preferred to first introduce organopolysiloxane (1), and the quaternary amine base (3) and optional polyetheramine (2) and optional primary or secondary amines (33) is added together, or the polyetheramine (2) can be added first and then the quaternary amine base (3), or the quaternary amine base (3) can be added first and then the polyetheramine (2). It is preferred to add the polyetheramine (2) first, then add the quaternary amine base (3), and finally add the optional primary or secondary amines (33).

The alcohol formed in this reaction is preferably removed, more preferably by distillation.

The method for preparing the silicone copolymer of the present invention can be carried out batchwise, semi-batchwise or continuously.

Examples of fibrous substrates which are treated with the compositions (A) comprising the silicone copolymers of the invention are natural or synthetically produced fibers, yarns, skeins, cables, sheet-like textile structures such as nonwovens, mats, woven, knotted or knitted textiles, leather and leatherette, and also hairs. Preferred fibrous substrates are textiles. For application of the composition of the invention, the textiles may take the form of individual fibers, fiber bundles, fiberfill fibers, yarns, carpets, fabric webs, or garments or parts of garments.

The textiles may consist of cotton, wool, copolymers of vinyl acetate, rayon, hemp, natural silk, polypropylene, polyethylene, polyester, polyurethane, polyamide, aramid, polyimide, polyacrylate, polyacrylonitrile, polylactide, polyvinyl chloride, glass fibers, ceramic fibers, cellulose or mixtures thereof.

Application to the fibrous substrates to be treated, preferably textiles, may take place in any desired manner which is suitable and widely known for the treatment of fibrous substrates, such as textiles—for example, by dipping, spreading, casting, spraying, rolling, padding, printing or foam application.

In the application, the composition of the invention may be combined with commonplace textile auxiliaries, such as, for example, binders comprising melamine resins or methylol resins, polyethylenes, polyurethanes, polyacrylates, polyvinyl alcohols, polyvinyl acetates, optical brighteners, flatting agents, electrolytes, wetting assistants, plastic resins, bleaches, antistats, dispersions of metal oxides, silicates, perfume oils, dyes and preservatives, defoamers or further hydrophobizing and oleophobizing assistants, such as perfluorinated hydrocarbons.

The products of the invention, furthermore, may be used with fabric softeners based on polysiloxanes and organic softeners such as anionic, cationic and nonionic softeners, and mixtures thereof.

These include functional and nonfunctional silicones, salts of the metal soaps, alkylpolysulfonates, sulfosuccinates and derivatives thereof, ester quats, sulfoalkylene fatty acid amides, alkylammonium sulfates, triethanolamine fatty acid esters, fatty acid polyglycol esters, fatty amine polyalkylene adducts, fatty acid amide polyalkylene adducts, and dispersions of paraffins, waxes, polyethylenes and polyesters.

The fibrous substrates treated, preferably textiles, are left to dry preferably at temperatures of 20° C. to 200° C., more preferably 100° C. to 180° C.

The silicone copolymers of the invention, and the compositions (A) comprising the silicone copolymers of the invention, have the advantage that the fibrous substrates treated with them, such as textiles, are hydrophilic, have a soft hand feel, and are easily emulsifiable.

In the examples described below, all references to parts and percentages, unless otherwise indicated, are by weight. Moreover, all viscosity references are based on a temperature of 25° C.

Unless otherwise specified, the Examples and Comparative Examples in Table 1 were carried out at the temperature reached during mixing at 50 mbar and about 85° C. The reaction time is between 0.5-5 h, preferably between 1-3 h.

In the present invention, Me represents methyl, and Et represents ethyl.

### EMBODIMENTS

Oxamidoester-terminated silicone oil (Mw=11 000 g/mol, Mn=7000 g/mol), bifunctionality, provided by Wacker Chem ie AG,
Tetramethylammonium hydroxide methanol solution, in which the content of TMAH is 25 wt %, based on the total solution is 100 wt %,
Dodecyltrimethylammonium chloride ethanol solution, in which the content of dodecyltrimethylammonium chloride is 25 wt %, based on the total solution is 100 wt %,
JEFFAMINE® ED-900, polyetheramine, available from Huntsman Performance Products, Everslaan 45, B3078 Everberg, Belgium,
DA102, N¹,N¹-dimethylpropane-1,3-diamine (available commercially from SIGMA-ALDRICH, MERCK, Darmstadt, Germany).

Preparation:

The oxamidoester-terminated organopolysiloxane (1) was charged in a 1000 ml four-neck flask with thermocouple, KPG stirrer and reflux condenser under stirring at 70-100° C. for 15 minutes Inside, add optional polyetheramine (2) and stir for 30-60 minutes. Then add the quaternary amine base (3) solution and stir for another 10 minutes. Thereafter, the small molecules produced are removed at 70-120° C. and a vacuum of 50 mbar for a duration of 2-4 hours. Then optionally add DA102, remove the small molecules produced at 70-120° C. and 50 mbar vacuum for 1-2 hours to obtain the copolymer. Determine its molecular weight by SEC.

TABLE 1

| | Ex.1 | Ex.3 | Ex4 | Ex.5 | C.Ex.6 | C.Ex.7 |
|---|---|---|---|---|---|---|
| oxamidoester-terminated silicone oil | 100.0 | 100.0 | 100 | 100.0 | 100.0 | 100.0 |
| MeOH | 648.3 | 696.16 | 1019.5 | 1707.00 | | |
| (from TMAH MeOH solution) | | | | | | |
| TMAH | 76.0 | 81.60 | 119.5 | 200.00 | | |
| (from TMAH MeOH solution) | | | | | | |
| EtOH | | | | | 3441.91 | |
| (from dodecyltrimethylammonium | | | | | | |
| chloride EtOH solution) | | | | | | |
| dodecyltrimethylammonium chloride | | | | | 200.00 | |
| (from dodecyltrimethylammonium | | | | | | |
| chloride EtOH solution) | | | | | | |
| JEFFAMINE® ED900 | 47.3 | | 47.3 | | | 47.2 |
| DA 102 | 99.0 | | | | | 99.8 |

The raw materials in Table 1 are pure substances, and the dosage is mmol.

TABLE 2-1

| | Ex.1 | Ex.3 | Ex4 | Ex.5 | C.Ex.6 | C.Ex.7 |
|---|---|---|---|---|---|---|
| COCOO-polyether amine | 26.6% | | 31.3% | | | 10.3% |
| structural unit | | | | | | |
| COCOO M⁺ | 50.3% | 35.6% | 65.2% | 89.20% | 0.0% | 0.0% |
| structural unit | | | | | | |
| -Si-Y-NH- | 100.1% | 100.0% | 100% | 100.0% | 100.0% | 100.1% |
| structural unit | | | | | | |

In Table 2-1, the relative mol % ratio of each functional group and structural unit is calculated by nuclear magnetic NMR Si²⁹, H¹ and C¹³ test. Among them, the —Si—Y—NH— structural unit has what it has in the general formula (I-a) meaning.

The inventor of the present case discovered the copolymer with (I-a) structural units could be obtained by using quaternary amine base materials. Compared with C.Ex. 7 without (I-a) structural units, the novel copolymer of the present invention (Ex. 1) has better hand feeling and hydrophilicity (shorter droplet absorption time). In addition, the novel copolymer of the present invention can simultaneously achieve good hydrophilicity and antibacterial properties. In addition, the new copolymer has a longer antibacterial effect and is more safe and more environmentally friendly.

TABLE 2-2

| | Ex. 1 | Ex. 4 | C. Ex. 7 |
|---|---|---|---|
| Mw | 24840 | 25080 | 21960 |
| Mn | 6661 | 4906 | 6667 |

[symbol]

3

| | | | |
|---|---|---|---|
| hand evaluation | 5 | 3 | 1 |
| Determination of | 5 | 4 | 5 |
| yellowing | | | |
| Determination of | 5 | 5 | 3 |
| droplet absorption | | | |
| time | | | |

[symbol]

4

| | [symbol] |
|---|---|
| Examples or Comparative examples | 41.00 |
| MULTISO 13/50 from Sasol | 10.25 |
| water | 150.00 |
| acetic acid | 0.41 |
| Total | 201.66 |

The raw materials in Table 4 are pure substances, and the dosage is gram.

Determination of Softness (Hand Evaluation):

Since the softness of textiles is greatly dependent on the subjective perception of the testers, only the boundary conditions, but not the evaluation, can be standardized. To ensure reproducibility nonetheless, the finished specimens were assessed and ranked in terms of their softness. For this purpose, four testers awarded points depending on the number of specimens tested, with the level of the point number correlating to the softness. The softest specimen receives the maximum point number, while the least soft specimen receives 0 points. The hand evaluation for a specimen is therefore calculated as the average value of the points scored by this particular specimen.

Determination of Droplet Absorption Time:

Following application of the silicone product, the finished specimen was stored for eight hours for acclimatization in a conditioning chamber at a temperature of 23° C. and an atmospheric humidity of 62%, and then a droplet of deionized water was placed on the taut fabric surface from a height of 1 cm, and a determination was made of the time taken for the fabric to absorb the water droplet—but no longer than three minutes (180 seconds).

Five determinations were carried out, and the results were averaged.

The hydrophilicity score is as follows: within 40 seconds is 5 score, within 50 seconds is 4 score, and within 60 seconds is 3 score.

Determination of Yellowing:

The degree of yellowing was ascertained using a spectro guide sphere Gloss® colorimeter (BYK GARDNER, Geretsried, Germany). The textile sample in this case is measured at three different points, and the average is found. This “average yellowing b+” is compared with the untreated sample.

Smaller b+ values denote decreasing yellowing.

1-9. (canceled)

10. A silicone copolymer containing a structural unit represented by the general formula (I-a), 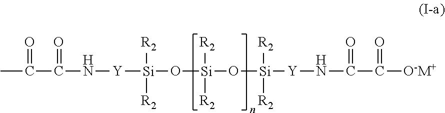
M is N(R¹)₄, R¹ is the same or different, and represents a monovalent hydrocarbon group having 1 to 18 carbon atoms, benzyl or adamantyl, preferably R¹ is methyl, ethyl, propyl, butyl, benzyl, dodecyl, octadecyl,
Y is a divalent hydrocarbon group, optionally substituted by one or more heteroatoms, preferably methylene, 1,2-ethylene, 1,3-propylene, 1,3-butylene, 1,4-butylene, 1,5-pentylene, 1,6-hexylene, —C₂H₄—NH—C₃H₆—,
R² is identical or different and denotes a monovalent hydrocarbon radical which has 1 to 18 carbon atoms and may comprise halogen or oxygen atoms, and
n is an integer from 10 to 2000.

11. The copolymer according to claim 1 containing the structural unit represented by the general formula (I-b): 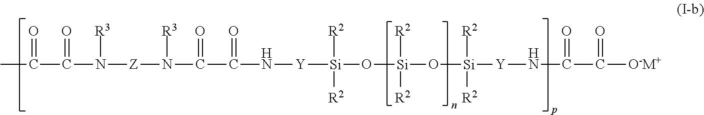
the group M is as defined above,
the group Z is a divalent hydrocarbyloxy group,
wherein R³ are the same or different, and are selected from hydrogen atoms or monovalent hydrocarbon groups with 1 to 20 carbon atoms, and
p is an integer of 1 to 5.

12. The copolymer according to claim 10 containing the structural unit represented by the general formula (I-c): 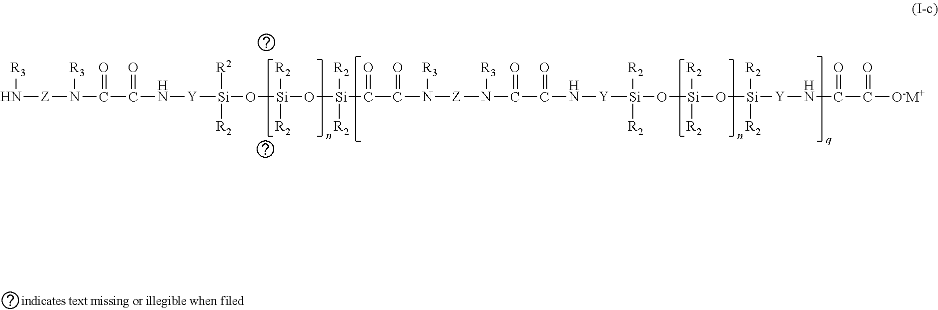
the groups M, R², and R³ are as defined above,
q is 0 or an integer of 1 to 5.

13. The copolymer according to claim 10 containing the structural unit represented by the general formula (I-d) and/or (I-d′): 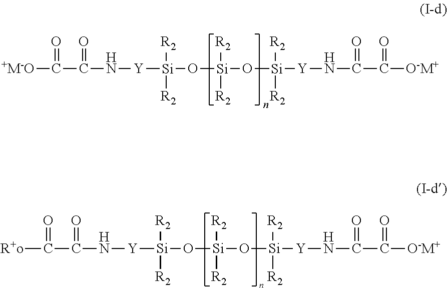
the groups M and R² are as defined above,
R* is a monovalent hydrocarbon group having 1 to 18 carbon atoms.

14. A method for preparing the copolymer according to claim 10 including
providing an organopolysiloxane containing a structural unit represented by general formula (II): 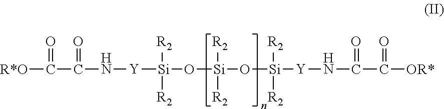
where R², Y, and n have the above-mentioned definitions for their indications, and
R* is a monovalent hydrocarbon group having 1 to 18 carbon atoms; and
reacting the organopolysiloxane represented by general formula (II) with the following component (3), and optional component (2):
quaternary amine base component (3) represented by general formula (III-3) compound
N(R¹)₄⁺X⁻ (III-3)
where R¹ has the same definition as above, X is OH,
wherein component (2) is the polyetheramine of R³HN—Z—NHR³ (III-2), R³ and Z have the definitions indicated above.

15. The method according to claim 14, the quaternary amine base (3) is used in the following amount: relative to every 100 moles of polymer in the organopolysiloxane (1), the amount of component (3) is greater than or equal to 10 mol.

16. The copolymer prepared according to the method of claim 14.

17. The use of the copolymer according to claim 10 in the textile field to improve the hydrophilicity or hand feel of textiles.

18. The use of the copolymer according to claim 10 to improve the hydrophilicity and antibacterial properties of textiles.
